(19) United States
(12) Patent Application Publication
(10) Pub. No.: US 2025/0139354 A1
(43) Pub. Date: May 1, 2025

(54) CONTEXT-ENRICHED PROMPT GENERATION FOR DOMAIN EXPLORATION

(71) Applicant: AUTODESK, INC., San Francisco, CA (US)

(72) Inventors: George William FITZMAURICE, Toronto (CA); Jo Karel VERMEULEN, East York (CA); Justin Frank MATEJKA, Newmarket (CA)

(21) Appl. No.: 18/798,408

(22) Filed: Aug. 8, 2024

Related U.S. Application Data
(60) Provisional application No. 63/593,915, filed on Oct. 27, 2023.

(51) Int. Cl. G06F 40/169

(52) U.S. Cl. CPC G06F 40/169

(57) ABSTRACT

In various embodiments, a computer-implemented method for generating context-enriched responses comprises generating a context enrichment based on a context input, combining the context enrichment with a prompt input to generate a context-enriched prompt, and executing a generative machine learning (ML) model on the context-enriched prompt to generate a context-enriched response.

### CROSS-REFERENCE TO RELATED APPLICATIONS

This application claims priority benefit of the United States Provisional Patent Application titled “MORE CONSISTENT PROMPTING USING IMAGES,” filed on Oct. 27, 2023, and having Ser. No. 63/593,915. The subject matter of this related application is hereby incorporated herein by reference.

### BACKGROUND

### Field of the Various Embodiments

The various embodiments relate generally to computer-aided design and artificial intelligence and, more specifically, to context-enriched prompt generation for domain exploration.

### Description of the Related Art

Text prompts are a common way for users to interact with generative machine learning (ML) models. In a typical interaction, a user inputs a text prompt to a generative ML model, where the text prompt broadly pertains to a given subject. In response, the generative ML model produces a response that is output to the user. Oftentimes, the response does not provide the user with a sufficient level of detail or is inaccurate for other reasons. The user typically then provides an additional text prompt to the generative ML model, thereby causing the generative ML model to produce an additional response. Interactions of this nature can repeat numerous times until the user obtains a response from the generative ML model having a desired level of detail and/or degree of accuracy.

The iterative process described above can become exceedingly complicated when the user seeks information pertaining to a specialized domain, such as a particular organization, or a unique body of knowledge. In such cases, the user typically must write very long and/or very detailed text prompts in order to obtain responses from the generative ML model that are relevant to the specialized domain. Writing such text prompts can be tedious and error prone. Moreover, the user may still need to interact with the generative AI model repeatedly, in an iterative fashion, before any meaningful responses can be obtained.

One approach to improving the interactive prompting process described above is a technique known as fine-tuning. Fine-tuning involves re-training the generative ML model using domain-specific training data. Once the fine-tuning process is complete, the generative ML model is intentionally biased to producing responses associated with the specific domain and using terminology relevant to that domain. When interacting with the fine-tuned generative ML model, the user can sometimes write shorter and/or less detailed prompts and still obtain satisfactory responses, and occasionally the user can obtain those responses with fewer interactions.

One drawback of the above approach is that the fine-tuning process specializes the generative ML model to one specific domain, while sacrificing generalization to other domains. Consequently, the fine-tuned generative ML model typically cannot produce accurate responses associated with other domains. As such, a different generative ML model subsequently needs to be fine-tuned for each different domain a user needs to explore. Fine-tuning multiple generative ML models relative to multiple different domains is a very complex and time-consuming process and, accordingly, quite inefficient and prone to error.

As the foregoing illustrates, what is needed in the art are more effective techniques for interacting with generative ML models.

### SUMMARY

In various embodiments, a computer-implemented method for generating context-enriched responses comprises generating additional context for a prompt input based on a context input, combining the additional context with the prompt input to generate a context-enriched prompt, and executing one or more generative machine learning (ML) models on the context-enriched prompt to generate the context-enriched response.

At least one technical advantage of the disclosed techniques relative to the prior art is that the disclosed techniques enable generative ML models to produce responses that are relevant to a particular domain of knowledge without requiring the user to write very long and/or very detailed prompts. Another technical advantage of the disclosed techniques is that generating context-enriched prompts using both prompt inputs and context inputs enables generative ML models to produce contextually-relevant responses without the need for domain-specific fine tuning. Accordingly, with the disclosed techniques, a user can more effectively obtain accurate and detailed information across many different domains. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the domain exploration application and the context management application of FIG. 1, according to various embodiments;

FIGS. 3A-3B are exemplar illustrations of the domain space and the prompt space of FIG. 2, according to various embodiments;

FIG. 4 sets forth a flow diagram of method steps for generating context-enriched responses, according to various embodiments; and

FIG. 5 depicts one architecture of a system within which embodiments of the present disclosure may be implemented.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

### System Overview

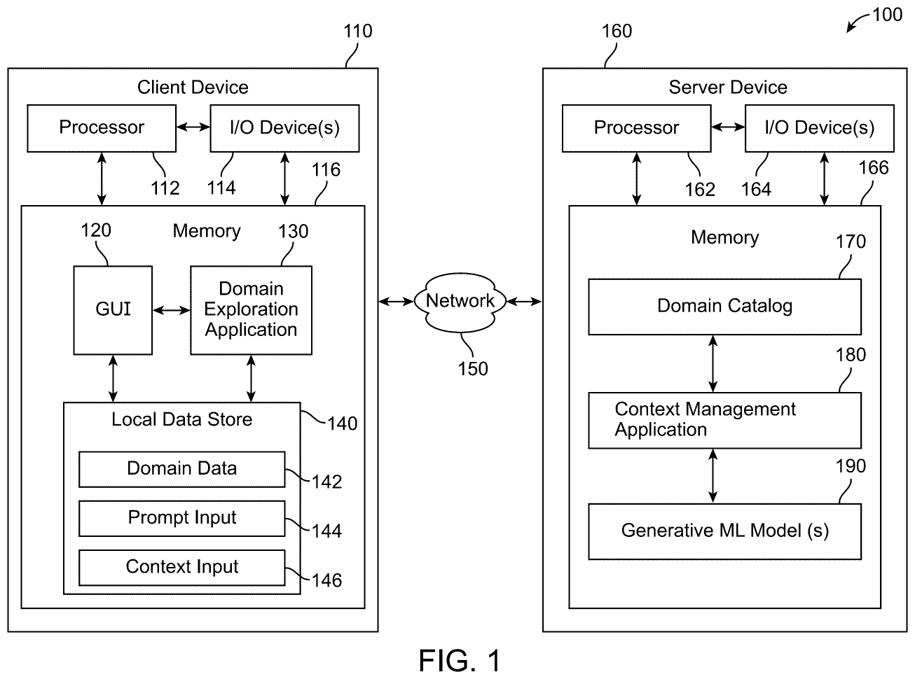

FIG. 1 is a conceptual illustration of a system 100 configured to implement one or more aspects of the various embodiments. As shown, in some embodiments, the system 100 includes, without limitation, a client device 110 and a server device 160. The client device 110 includes, without limitation, a processor 112, one or more input/output (I/O) devices 114, and a memory 116. The memory 116 includes, without limitation, a graphical user interface (GUI) 120, a domain exploration application 130, and a local data store 140. The local data store 140 includes, without limitation, domain data 142, prompt input 144, and context input 146. The server device 160 includes, without limitation, a processor 162, one or more I/O devices 164, and a memory 166. The memory 166 includes, without limitation, a domain catalog 170, a context management application 180, and generative ML model(s) 190. In some other embodiments, the system 100 can include any number and/or types of other client devices, server devices, additional ML models, or any combination thereof.

Any number of the components of the system 100 can be distributed across multiple geographic locations or implemented in one or more cloud computing environments (e.g., encapsulated shared resources, software, data) in any combination. In some embodiments, the client device 110 and/or zero or more other client devices (not shown) can be implemented as one or more compute instances in a cloud computing environment, implemented as part of any other distributed computing environment, or implemented in a stand-alone fashion. In various embodiments, the client device 110 can be integrated with any number and/or types of other devices (e.g., one or more other compute instances and/or a display device) into a user device. Some examples of user devices include, without limitation, desktop computers, laptops, smartphones, and tablets.

In general, the client device 110 is configured to implement one or more software applications. For explanatory purposes only, each software application is described as residing in the memory 116 of the client device 110 and executing on the processor 112 of the client device 110. In some embodiments, any number of instances of any number of software applications can reside in the memory 116 and any number of other memories associated with any number of other compute instances and execute on the processor 112 of the client device 110 and any number of other processors associated with any number of other compute instances in any combination. In the same or other embodiments, the functionality of any number of software applications can be distributed across any number of other software applications that reside in the memory 116 and any number of other memories associated with any number of other compute instances and execute on the processor 112 and any number of other processors associated with any number of other compute instances in any combination. Further, subsets of the functionality of multiple software applications can be consolidated into a single software application.

In particular, the client device 110 is configured to implement a domain exploration application 130 that allows a user to obtain information associated with a given domain. In the context of this disclosure, a “domain” generally refers to a specialized body of knowledge associated with a given topic, organization, subject, or any other categorical grouping of information. In operation, the design exploration application 130 interacts with a context management application 180 to generate prompts that are contextually directed towards a given domain. The generative ML model(s) 190 can then process those prompts to provide the user with information that is contextually relevant to the given domain.

In various embodiments, the processor 112 can be any instruction execution system, apparatus, or device capable of executing instructions. For example, the processor 112 could comprise a central processing unit (CPU), a digital signal processing unit (DSP), a microprocessor, an application-specific integrated circuit (ASIC), a neural processing unit (NPU), a graphics processing unit (GPU), a field-programmable gate array (FPGA), a controller, a microcontroller, a state machine, or any combination thereof. In some embodiments, the processor 112 is a programmable processor that executes program instructions to manipulate input data. In some embodiments, the processor 112 can include any number of processing cores, memories, and other modules for facilitating program execution.

The input/output (I/O) devices 114 include devices configured to receive input, including, for example, a keyboard, a mouse, and so forth. In some embodiments, the I/O devices 114 also includes devices configured to provide output, including, for example, a display device, a speaker, and so forth. Additionally or alternatively, the I/O devices 114 may further include devices configured to both receive and provide input and output, respectively, including, for example, a touchscreen, a universal serial bus (USB) port, and so forth.

The memory 116 includes a memory module, or collection of memory modules. In some embodiments, the memory 116 can include a variety of computer-readable media selected for their size, relative performance, or other capabilities: volatile and/or non-volatile media, removable and/or non-removable media, etc. The memory 116 can include cache, random access memory (RAM), storage, etc. The memory 116 can include one or more discrete memory modules, such as dynamic RAM (DRAM) dual inline memory modules (DIMMs). Of course, various memory chips, bandwidths, and form factors may alternately be selected. The memory 116 stores content, such as software applications and data, for use by the processor 112. In some embodiments, a storage (not shown) supplements or replaces the memory 116. The storage can include any number and type of external memories that are accessible to the processor 112 of the client device 110. For example, and without limitation, the storage can include a Secure Digital (SD) Card, an external Flash memory, a portable compact disc read-only memory, an optical storage device, a magnetic storage device, or any suitable combination of the foregoing.

Non-volatile memory included in the memory 116 generally stores one or more application programs including the domain exploration application 130, and data (e.g., the domain data 142, the prompt input 144, and the context input 146 stored in the local data store 140) for processing by the processor 112. In various embodiments, the memory 116 can include non-volatile memory, such as optical drives, magnetic drives, flash drives, or other storage. In some embodiments, separate data stores, such as one or more external data stores connected via the network 150 (“cloud storage”) can supplement the memory 116. In various embodiments, the domain exploration application 130 within the memory 116 can be executed by the processor 112 to implement the overall functionality of the client device 110 to coordinate the operation of the system 100 as a whole.

In various embodiments, the memory 116 can include one or more modules for performing various functions or techniques described herein. In some embodiments, one or more of the modules and/or applications included in the memory 116 may be implemented locally on the client device 110, and/or may be implemented via a cloud-based architecture. For example, any of the modules and/or applications included in the memory 116 could be executed on a remote device (e.g., smartphone, a server system, a cloud computing platform, etc.) that communicates with the client device 110 via a network interface or an I/O devices interface.

The domain exploration application 130 resides in the memory 116 and executes on the processor 112 of the client device 110. The domain exploration application 130 interacts with the user via the GUI 120. In some embodiments, the domain exploration application 130 and one or more separate applications (not shown) interact with the same user via the GUI 120. In various embodiments, the domain exploration application 130 interacts with the user via the GUI 120 to display the domain data 142 to the user. The domain data 142 generally includes one or more images associated with a given domain. For example, and without limitation, the domain data 142 could include an image of a factory floor, a schematic of a set of circuits, a map of a group of buildings, a blueprint of a structure, a medical image reflecting a portion of a person, and so forth. The domain data 142 is derived from the domain catalog 170, which includes various domain data associated with multiple different domains.

The GUI 120 receives the prompt input 144 and the context input 146 from the user. The prompt input 144 includes text corresponding to an area or topic of the given domain the user wants to explore. The context input 146 references a specific portion of the domain data 142. In one embodiment, the context input 146 may include a cursor location within the domain data 142 and/or a selected region of the domain data 142. The domain exploration application 130 transmits the prompt input 144 and the context input 146 to the context management application 180 for further processing. In one embodiment, the domain exploration application 130 may generate a compound prompt that includes both the prompt input 144 and the context input 146.

The GUI 120 can be any type of user interface that allows users to interact with one or more software applications via any number and/or types of GUI elements. The GUI 120 can be displayed in any technically feasible fashion on any number and/or types of stand-alone display device, any number and/or types of display screens that are integrated into any number and/or types of user devices, or any combination thereof. The domain exploration application 130 can perform any number and/or types of operations to directly and/or indirectly display and monitor any number and/or types of interactive GUI elements and/or any number and/or types of non-interactive GUI elements within the GUI 120. In some embodiments, each interactive GUI element enables one or more types of user interactions that automatically trigger corresponding user events. Some examples of types of interactive GUI elements include, without limitation, scroll bars, buttons, text entry boxes, drop-down lists, and sliders. In some embodiments, the domain exploration application 130 organizes GUI elements into one or more container GUI elements (e.g., panels and/or panes).

The network 150 can be any technically feasible set of interconnected communication links, including a local area network (LAN), wide area network (WAN), the World Wide Web, or the Internet, among others. The network 150 enables communications between the client device 110 and other devices in the network 150 via wired and/or wireless communications protocols, including Bluetooth, Bluetooth low energy (BLE), wireless local area network (WiFi), cellular protocols, satellite networks, and/or near-field communications (NFC).

The server device 160 is configured to communicate with the design exploration application 130 to process the prompt input 144 and the context input 146. In operation, the server device 160 executes the context management application 180 to generate one or more context-enriched prompts (not shown here) based on the prompt input 144 and the context input 146. The generative ML model(s) 190 then process the context-enriched prompts to generate one or more context-enriched responses (not shown here).

In various embodiments, the processor 162 can be any instruction execution system, apparatus, or device capable of executing instructions. For example, the processor 162 could comprise a central processing unit (CPU), a digital signal processing unit (DSP), a microprocessor, an application-specific integrated circuit (ASIC), a neural processing unit (NPU), a graphics processing unit (GPU), a field-programmable gate array (FPGA), a controller, a microcontroller, a state machine, or any combination thereof. In some embodiments, the processor 162 is a programmable processor that executes program instructions to manipulate input data. In some embodiments, the processor 162 can include any number of processing cores, memories, and other modules for facilitating program execution.

The input/output (I/O) devices 164 include devices configured to receive input, including, for example, a keyboard, a mouse, and so forth. In some embodiments, The I/O devices 164 also includes devices configured to provide output, including, for example, a display device, a speaker, and so forth. Additionally or alternatively, the I/O devices 164 may further include devices configured to both receive and provide input and output, respectively, including, for example, a touchscreen, a universal serial bus (USB) port, and so forth.

The memory 166 includes a memory module, or collection of memory modules. In some embodiments, the memory 166 can include a variety of computer-readable media selected for their size, relative performance, or other capabilities: volatile and/or non-volatile media, removable and/or non-removable media, etc. The memory 166 can include cache, random access memory (RAM), storage, etc. The memory 166 can include one or more discrete memory modules, such as dynamic RAM (DRAM) dual inline memory modules (DIMMs). Of course, various memory chips, bandwidths, and form factors may alternately be selected. The memory 166 stores content, such as software applications and data, for use by the processor 162. In some embodiments, a storage (not shown) supplements or replaces the memory 166. The storage can include any number and type of external memories that are accessible to the processor 162 of the server device 160. For example, and without limitation, the storage can include a Secure Digital (SD) Card, an external Flash memory, a portable compact disc read-only memory, an optical storage device, a magnetic storage device, or any suitable combination of the foregoing.

Non-volatile memory included in the memory 166 generally stores one or more application programs including the context management application 180 and the generative ML model(s) 190, and data (e.g., the domain catalog 170) for processing by the processor 112. In various embodiments, the memory 166 can include non-volatile memory, such as optical drives, magnetic drives, flash drives, or other storage. In some embodiments, separate data stores, such as one or more external data stores connected via the network 150 can supplement the memory 166. In various embodiments, the context management application 180 and/or the generative ML models 190 within the memory 166 can be executed by the processor 162 to implement the overall functionality of the server device 160 to coordinate the operation of the system 100 as a whole.

In various embodiments, the memory 166 can include one or more modules for performing various functions or techniques described herein. In some embodiments, one or more of the modules and/or applications included in the memory 166 may be implemented locally on the client device 110, the server device 160, and/or may be implemented via a cloud-based architecture. For example, any of the modules and/or applications included in the memory 166 could be executed on a remote device (e.g., smartphone, a server system, a cloud computing platform, etc.) that communicates with the server device 160 via a network interface or an I/O devices interface. Additionally or alternatively, the context management application 180 could be executed on the client device 110 and can communicate with the generative ML model(s) 190 operating at the server device 160.

In various embodiments, the context management application 180 receives various inputs from the domain exploration application 130, including the prompt input 144 and the context input 146, and based on those inputs interacts with the generative ML model(s) 190. In some embodiments, one or more of the generative ML model(s) 190 are trained to respond to specific types of inputs, such as an ML model that is trained to generate text-based responses from a specific combination of modalities (e.g., text and images). In such instances, the context management application 180 processes various inputs to determine the modalities of the data included therein and identifies one or more of the ML model(s) 190 that have been trained to respond to such a combination of modalities. Upon identifying the one or more ML models 190, the context management application 180 selects an ML model and inputs the prompt into the selected ML model 190.

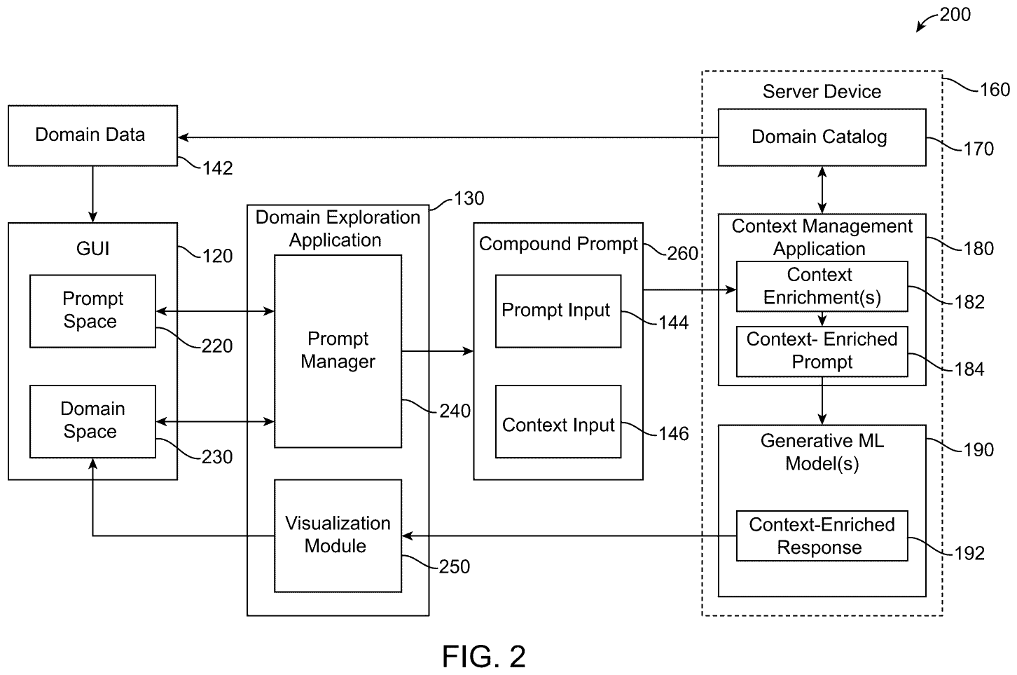

The generative ML model(s) 190 include one or more ML models that have been trained on a relatively large amount of existing data to perform any number and/or types of prediction tasks based on patterns detected in the existing data. In some embodiments, a given trained ML model 190 is trained using various combinations of data from multiple modalities, such as textual data, image data, sound data, and so forth. The generative ML model(s) 190 that are trained using at least two modalities of data are also referred to herein as multimodal ML model(s). For example, in some embodiments, one or more trained ML models 190 can include a third-generation Generative Pre-Trained Transformer (GPT-3) model, a specialized version of a GPT-3 model referred to as a “DALL-E2” model, a fourth-generation Generative Pre-Trained Transformer (GPT-4) model, and so forth. In various embodiments, the generative ML model(s) 190 can be trained to generate responses based on one or more context-enriched prompts the context management application 180 generates based on the prompt input 144 and the context input 146, as described in greater detail below in conjunction with FIG. 2.

FIG. 2 is a more detailed illustration of the design exploration application 130 and the context management application 180 of FIG. 1, according to various embodiments. As shown, in some embodiments, the system 200 includes, without limitation, the GUI 120, the domain exploration application 130, and the server device 160. The GUI 120 includes, without limitation, a prompt space 220 and a domain space 230. The domain exploration application 130 includes, without limitation, a prompt manager 240 and a visualization module 250. The server device 160 includes, without limitation, the domain catalog 170, the context management application 180, and the generative ML model(s) 190.

For explanatory purposes only, the functionality of the domain exploration application 130 and the context management application 180 is described herein in the context of exemplar interactive and linear workflows. As persons skilled in the art will recognize, the techniques described herein are illustrative rather than restrictive and can be altered and applied in other contexts without departing from the broader spirit and scope of the inventive concepts described herein.

In operation, the visualization module 250 generates the GUI 120, including the prompt space 220 and the domain space 230. The prompt space 220 generally includes GUI elements for receiving text input. The domain space 230 generally includes GUI elements for displaying the domain data 142, including 2D and/or 3D images derived from the domain catalog 170. In one embodiment, a user may select the domain data 142 from the domain catalog 170 via the GUI 120. The domain space 230 also includes GUI elements that allow the user to select portions of such images, including a cursor, among others. The prompt manager 240 interacts with the prompt space 220 to obtain the prompt input 144 from the user. The prompt manager 240 also interacts with the domain space 230 to obtain the context input 146 from the user.

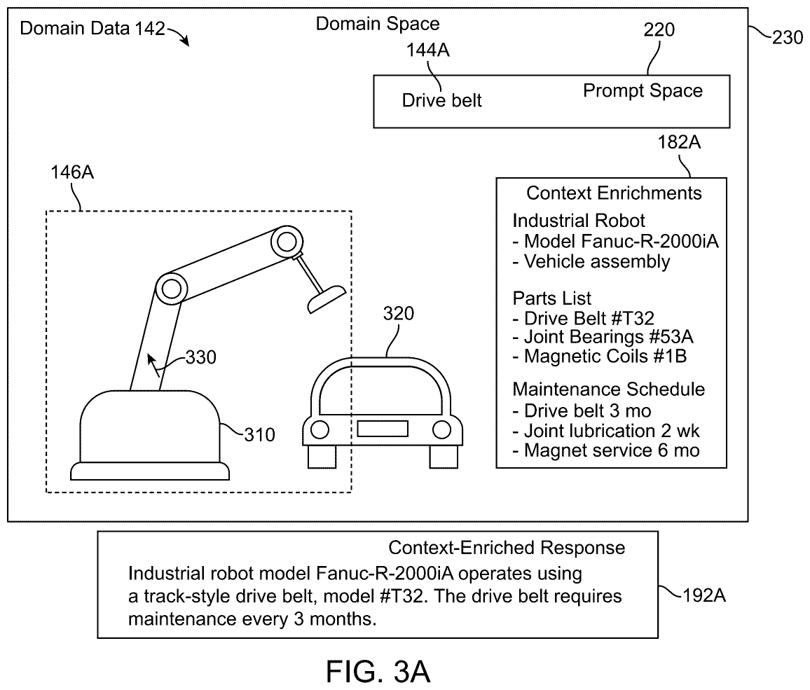

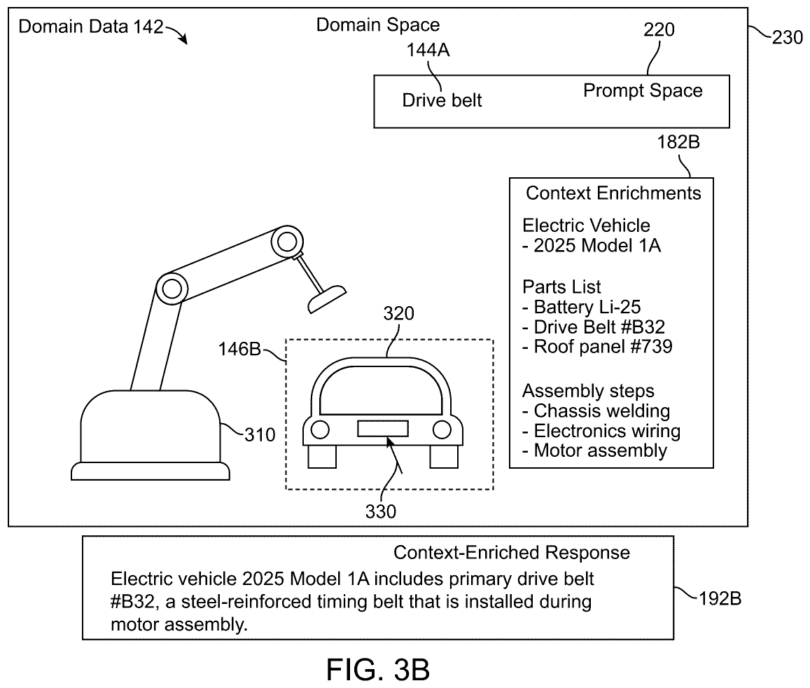

The prompt input 144 is a text prompt that is directed, to some degree, to a domain associated with the domain data 142. For example, suppose the domain data 142 includes an image of a factory floor where a set of industrial robots perform vehicle assembly. The prompt input 144 could include the text “drive belt” in reference to an object shown on the factory floor. The context input 146 includes contextual data that is derived from at least a portion of the domain data 142. In the above example, the context input 146 could include a subset of the image of the factory floor depicting a specific industrial robot. This particular example is described in greater detail below in conjunction with FIGS. 3A-3B.

The prompt manager 240 generates a compound prompt 260 to include both the prompt input 144 and the context input 146. In one embodiment, the compound prompt 260 may be a multimodal prompt that includes data associated with two distinct modalities. For example, and without limitation, the prompt input 144 could include text, while the context input 146 could include one or more images (as also described previously). In various other embodiments, the prompt input 144 and the context input 146 correspond to a single modality (e.g., text only).

The context management application 180 is configured to process the compound prompt 260 to generate one or more context enrichment(s) 182 that include additional context associated with the domain. In one embodiment, the context enrichment(s) 182 may include text that describes the contents of one or more images included in the context input 146. Such text may be derived from annotations and/or labels already present within the domain data 142, or generated by an ML model that is configured to provide textual descriptions, annotations, and/or labels for images. Based on the context enrichment(s) 182, the context management application 180 generates a context-enriched prompt 184. The context-enriched prompt 184 is a modified version of the prompt input 144 that is expanded to include the context enrichment(s) 182. In one embodiment, the context-enriched prompt 184 may be a concatenation of the prompt input 144 and additional descriptive text included in the context enrichment(s) 182. The context management application 180 inputs the context-enriched prompt 184 to the generative ML model(s) 190.

The generative ML model(s) 190 generate a context-enriched response 192 based on the context-enriched prompt 184. The context-enriched response 192 can then be displayed to the user via GUI 120. The context-enriched response 192 is generally text that provides information that is contextually relevant to the input prompt 144. Importantly, because the context-enriched response 192 is generated based on the contextual background information associated with the context input 146 and, likewise, the context enrichments 182, the context-enriched response 192 is more likely to be accurate and provide a sufficient degree of detail than otherwise possible with conventional prompting techniques. Accordingly, via the techniques described, the user can efficiently explore a given domain and obtain contextually-relevant information associated with that domain without needing to write very long and/or very detailed prompts. Further, the generative ML model(s) 190 need not be fine-tuned for any specific domain, because the context-enriched prompt 184 already includes the domain-specific information needed to correctly interpret and respond to the input prompt 144.

In one embodiment, the context management application 180 may generate the context enrichments 182 based further on a prompt history that corresponds to the user, the domain the user explores, or the generative ML model(s) 190. The prompt history could include, for example and without limitation, common terminology associated with the domain that could be leveraged to provide more accurate responses. As a general matter, the context management application 180 can generate the context enrichment(s) 182 based on any technically feasible data that is relevant to the prompt input 144.

### Generating Context-Enriched Prompts

FIGS. 3A-3B are exemplar illustrations of the domain space and the prompt space of FIG. 2, according to various embodiments. As shown in FIG. 3A, the domain space 230 includes domain data 142 that is associated with an industrial manufacturing environment. In the example shown, the domain data 142 is an image depicting an industrial robot 330 that performs an assembly step relative to a vehicle 320.

The prompt space 220 includes the prompt input 144A. In the example shown, the prompt input 144A is the text “drive belt.” The domain exploration application 130 generally receives the prompt input 144A from the user via a keyboard or other input device. The domain space 230 includes context input 146A that includes a portion of the domain data 142 specifically corresponding to the industrial robot 310. The domain exploration application 130 generally receives the context input 146A from the user via a cursor 330. The user could, for example and without limitation, select the industrial robot 310 directly via the cursor 330, or select an area of the domain data 142 that includes the industrial robot 310 by dragging a selection rectangle, among other techniques.

Based on the prompt input 144A and the context input 146A, the context management application 180 generates the context enrichments 182A. As is shown, the context enrichments 182A include various background information associated with the industrial robot 310, such as a model number, a function, a list of parts, and a maintenance schedule. Based on these context enrichments, the context management application 180 causes the generative ML model(s) 190 to generate the context-enriched response 192A. In this example, the context-enriched response 192A provides specific details associated with the drive belt of the industrial robot 310. Importantly, because the context management application 180 provides the generative ML models 190 with the additional background information set forth in the context enrichments 182A, the generative ML model(s) can interpret the relatively generic text “drive belt” as specifically pertaining to the industrial robot 310. A related example is described below in conjunction with FIG. 3B.

Referring now to FIG. 3B, as shown, the prompt space 220 includes the same prompt input 144A shown in FIG. 3A. However, the domain space 230 now includes context input 146B that includes a portion of the domain data 142 specifically corresponding to the vehicle 320. The domain exploration application 130 generally receives the context input 146B from the user via the cursor 330 in similar fashion as described above in conjunction with FIG. 3A. Based on the prompt 144A and the context input 146B, the context management application 180 generates the context enrichments 182B, which include various background information associated with the vehicle 320. Here, those context enrichments specify the vehicle type, a parts list, and set of assembly steps. Based on the context enrichments 182B, the context management application 180 causes the generative ML model(s) 190 to generate the context-enriched response 192B, which provides details related to a drive belt associated with the vehicle 320. Although the context management application 180 receives the same prompt input 144A as in FIG. 3A (“drive belt”), because context input 146B specifically references the vehicle 320, the generative ML model(s) 190 can interpret that text as pertaining to the vehicle 320.

The examples set forth in conjunction with FIGS. 3A-3B illustrate how the context management application 180 interoperates with the domain exploration application 130 to improve upon how users obtain information associated with a given domain. By providing contextual information to the generative ML model(s) 190, the generative ML model(s) 190 are capable of providing users with contextually-relevant information, and using terminology pertinent to that domain.

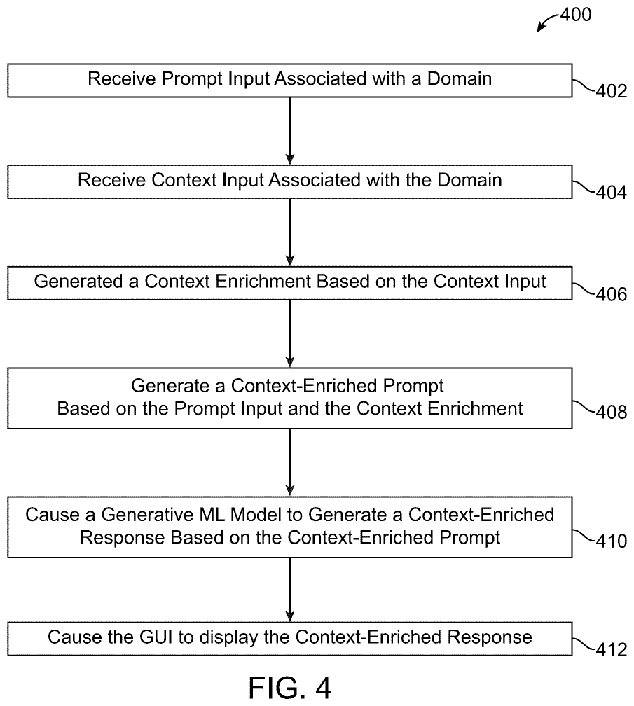

FIG. 4 sets forth a flow diagram of method steps for generating context-enriched responses, according to various embodiments. Although the method steps are described with reference to the systems of FIGS. 1-3B, persons skilled in the art will understand that any system configured to implement the method steps, in any order, falls within the scope of the embodiments.

As shown, a method 400 begins at step 402, where the context management application 180 receives the prompt input 144 associated with a given domain. The prompt input 144 is generally text-based data that is obtained by the domain exploration application 130 from the user via the GUI 120. At step 404, the context management application 180 also receives the context input 146 associated with the given domain. The context input 146 is generally a subset of the domain data 142 that is obtained from the user via the GUI 120. In various embodiments, the domain exploration application 130 may generate the compound prompt 260 that includes both the prompt input 144 and the context input 146. The compound prompt could be, for example and without limitation, a multimodal prompt, where the prompt input 144 is text-based while the context input 146 is image-based.

At step 406, the context management application 180 generates the context enrichment(s) 182 based on the context input 146. In one embodiment, the context enrichment(s) 182 may include text that describes the contents of one or more images included in the context input 146. Such text may be derived from annotations and/or labels already present within domain data 142, or, alternatively, may be generated by an ML model that is configured to provide textual descriptions of images and/or annotations to images.

At step 408, the context management application 180 generates the context-enriched prompt 184 based on the prompt input 144 and the context enrichments 182. The context-enriched prompt 184 is a modified version of the prompt input 144 that is expanded to include the context enrichment(s) 182. In one embodiment, the context-enriched prompt 184 may be a concatenation of the prompt input 144 and additional descriptive text derived from the context enrichment(s) 182. The context management application 180 inputs the context-enriched prompt 184 to the generative ML model(s) 190.

At step 410, the context management application 180 causes one or more of the generative ML model(s) 190 to generate the context-enriched response 192. The context-enriched response 192 is generally text that provides information relevant to the input prompt 144. Importantly, because the context-enriched response 192 is generated based on the contextual background information associated with the context input 146 and the context enrichments 182, the context-enriched response 192 is more likely to be accurate and provide a sufficient degree of detail than otherwise possible with conventional prompting techniques. Accordingly, via the techniques described, the user can efficiently explore a given domain and obtain contextually relevant information associated with that domain without needing to write very long and/or very detailed prompts. Further, the generative ML models 190 need not be fine-tuned for any specific domain, because the context-enriched prompt 184 already includes the domain-specific information needed to correctly interpret the input prompt 144. At step 412, the GUI 120 displays the context-enriched response 192 to the user.

### System Implementation

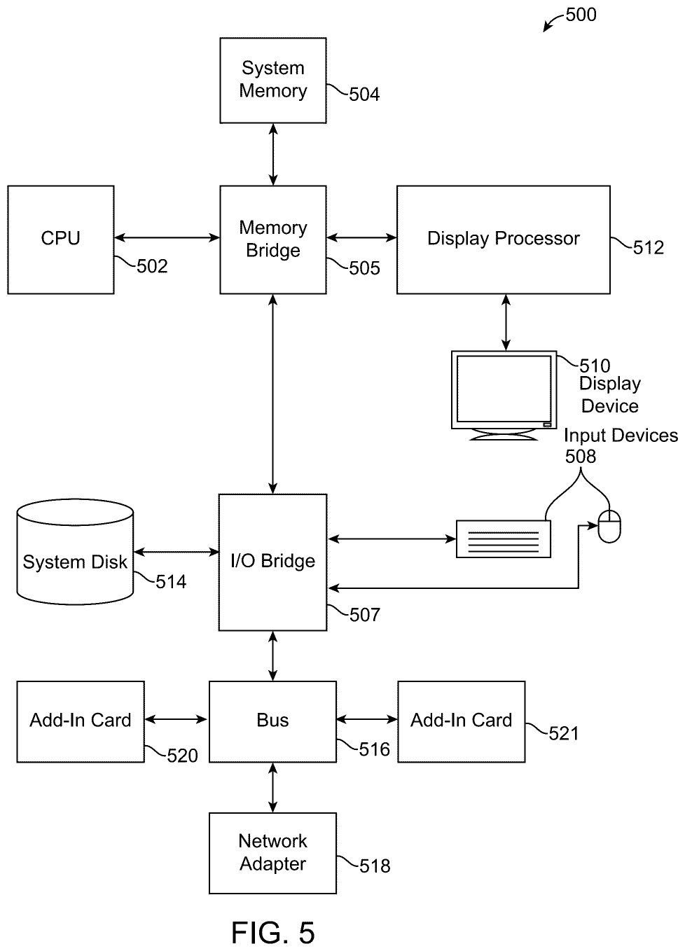

FIG. 5 depicts one architecture of a system 500 within which embodiments of the present disclosure may be implemented. This figure in no way limits or is intended to limit the scope of the present disclosure. In various implementations, system 500 may be an augmented reality, virtual reality, or mixed reality system or device, a personal computer, video game console, personal digital assistant, mobile phone, mobile device, or any other device suitable for practicing one or more embodiments of the present disclosure. Further, in various embodiments, any combination of two or more systems 500 may be coupled together to practice one or more aspects of the present disclosure.

As shown, system 500 includes a central processing unit (CPU) 502 and a system memory 504 communicating via a bus path that may include a memory bridge 505. CPU 502 includes one or more processing cores, and, in operation, CPU 502 is the master processor of system 500, controlling and coordinating operations of other system components. System memory 504 stores software applications and data for use by CPU 502. CPU 502 runs software applications and optionally an operating system. Memory bridge 505, which may be, e.g., a Northbridge chip, is connected via a bus or other communication path (e.g., a HyperTransport link) to an I/O (input/output) bridge 507. I/O bridge 507, which may be, e.g., a Southbridge chip, receives user input from one or more user input devices 508 (e.g., keyboard, mouse, joystick, digitizer tablets, touch pads, touch screens, still or video cameras, motion sensors, and/or microphones) and forwards the input to CPU 502 via memory bridge 505.

A display processor 512 is coupled to memory bridge 505 via a bus or other communication path (e.g., a PCI Express, Accelerated Graphics Port, or HyperTransport link); in one embodiment display processor 512 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 504.

Display processor 512 periodically delivers pixels to a display device 5110 (e.g., a screen or conventional CRT, plasma, OLED, SED or LCD based monitor or television). Additionally, display processor 512 may output pixels to film recorders adapted to reproduce computer generated images on photographic film. Display processor 512 can provide display device 510 with an analog or digital signal. In various embodiments, one or more of the various graphical user interfaces set forth in Appendices A-J, attached hereto, are displayed to one or more users via display device 510, and the one or more users can input data into and receive visual output from those various graphical user interfaces.

A system disk 514 is also connected to I/O bridge 507 and may be configured to store content and applications and data for use by CPU 502 and display processor 512. System disk 514 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 516 provides connections between I/O bridge 507 and other components such as a network adapter 518 and various add-in cards 520 and 521. Network adapter 518 allows system 500 to communicate with other systems via an electronic communications network, and may include wired or wireless communication over local area networks and wide area networks such as the Internet.

Other components (not shown), including USB or other port connections, film recording devices, and the like, may also be connected to I/O bridge 507. For example, an audio processor may be used to generate analog or digital audio output from instructions and/or data provided by CPU 502, system memory 504, or system disk 514. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 512 incorporates circuitry optimized for graphics and video processing, including, for example, video output circuitry, and constitutes a graphics processing unit (GPU). In another embodiment, display processor 512 incorporates circuitry optimized for general purpose processing. In yet another embodiment, display processor 512 may be integrated with one or more other system elements, such as the memory bridge 505, CPU 502, and I/O bridge 507 to form a system on chip (SoC). In still further embodiments, display processor 512 is omitted and software executed by CPU 502 performs the functions of display processor 512.

Pixel data can be provided to display processor 512 directly from CPU 502. In some embodiments of the present disclosure, instructions and/or data representing a scene are provided to a render farm or a set of server computers, each similar to system 500, via network adapter 518 or system disk 514. The render farm generates one or more rendered images of the scene using the provided instructions and/or data. These rendered images may be stored on computer-readable media in a digital format and optionally returned to system 500 for display. Similarly, stereo image pairs processed by display processor 512 may be output to other systems for display, stored in system disk 514, or stored on computer-readable media in a digital format.

Alternatively, CPU 502 provides display processor 512 with data and/or instructions defining the desired output images, from which display processor 512 generates the pixel data of one or more output images, including characterizing and/or adjusting the offset between stereo image pairs. The data and/or instructions defining the desired output images can be stored in system memory 504 or graphics memory within display processor 512. In an embodiment, display processor 512 includes 3D rendering capabilities for generating pixel data for output images from instructions and data defining the geometry, lighting shading, texturing, motion, and/or camera parameters for a scene. Display processor 512 can further include one or more programmable execution units capable of executing shader programs, tone mapping programs, and the like.

Further, in other embodiments, CPU 502 or display processor 512 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 502, display processor 512, or one or more other processing devices or any combination of these different processors.

CPU 502, render farm, and/or display processor 512 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 500 may be a robot or robotic device and may include CPU 502 and/or other processing units or devices and system memory 504. In such embodiments, system 500 may or may not include other elements shown in FIG. 1. System memory 504 and/or other memory units or devices in system 500 may include instructions that, when executed, cause the robot or robotic device represented by system 500 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 504 is connected to CPU 502 directly rather than through a bridge, and other devices communicate with system memory 504 via memory bridge 505 and CPU 502. In other alternative topologies display processor 512 is connected to I/O bridge 507 or directly to CPU 502, rather than to memory bridge 505. In still other embodiments, I/O bridge 507 and memory bridge 505 might be integrated into a single chip. The particular components shown herein are optional; for instance, any number of add-in cards or peripheral devices might be supported. In some embodiments, switch 516 is eliminated, and network adapter 518 and add-in cards 520, 521 connect directly to I/O bridge 507.

In sum, the domain exploration application 130 receives the prompt input 144 from the user via the prompt space 220 within the GUI 120. The prompt input 144 generally includes text. The domain exploration application 130 also receives the context input 146 from the user via the domain space 230. The context input 146 generally includes a subset of the domain data 142, and specifically includes a portion of an image associated with a particular domain the user explores. The context management application 180 analyzes the context input 146 to generate one or more context enrichments 182. A given context enrichment includes additional background information associated with the domain and provides context for interpreting the prompt input 144. The context management application 180 generates the context-enriched prompt 184 based on the prompt input 142 and the context enrichments 182. Then, the generative ML model(s) 190 generate the context-enriched response 192 based on the context-enriched prompt 184. The context-enriched response 192 includes text that provides information relevant to the input prompt 144 and the domain the user explores.

At least one technical advantage of the disclosed techniques relative to the prior art is that the disclosed techniques enable generative ML models to produce responses that are relevant to a particular domain of knowledge without requiring the user to write very long and/or very detailed prompts. Another technical advantage of the disclosed techniques is that generating context-enriched prompts using both prompt inputs and context inputs enables generative ML models to produce contextually-relevant responses without the need for domain-specific fine tuning. Accordingly, with the disclosed techniques, a user can more effectively obtain accurate and detailed information across many different domains without needing to fine tune a different generative ML model for each different domain. These technical advantages provide one or more technological advancements over prior art approaches.
1. In various embodiments, a computer-implemented method for generating a context-enriched response comprises generating additional context for a prompt input based on a context input, combining the additional context with the prompt input to generate a context-enriched prompt, and executing one or more generative machine learning (ML) models on the context-enriched prompt to generate the context-enriched response.
2. The computer-implemented method of clause 1, wherein the context input comprises a first portion of an image.
3. The computer-implemented method of any of clauses 1-2, wherein generating the additional context comprises causing a generative ML model to generate a description of the first portion of the image.
4. The computer-implemented method of any of clauses 1-3, wherein generating the additional context comprises determining a first set of annotations corresponding to the first portion of the image.
5. The computer-implemented method of any of clauses 1-4, wherein generating the additional context comprises identifying a first object within the first portion of the image, and generating a first set of data corresponding to the first object.
6. The computer-implemented method of any of clauses 1-5, wherein the additional context comprises a first portion of text, the prompt input comprises a second portion of text, and combining the additional context with the prompt input comprises concatenating the first portion of text and the second portion of text.
7. The computer-implemented method of any of clauses 1-6, further comprising receiving a compound prompt that includes the prompt input and the context input.
8. The computer-implemented method of any of clauses 1-7, wherein the compound prompt comprises a multimodal prompt.
9. The computer-implemented method of any of clauses 1-8, wherein the context input comprises a portion of domain data derived from a domain catalog, and the domain data corresponds to a first domain of knowledge, and the domain catalog corresponds to a plurality of different domains of knowledge.
10. The computer-implemented method of any of clauses 1-9, wherein at least a portion of the additional context comprises a prompt history associated with the generative ML model.
11. In various embodiments, one or more non-transitory computer-readable media include instructions that, when executed by one or more processors, cause the one or more processors to generate a context-enriched response by performing the steps of generating additional context for a prompt input based on a context input, combining the additional context with the prompt input to generate a context-enriched prompt, and executing one or more generative machine learning (ML) models on the context-enriched prompt to generate the context-enriched response.
12. The non-transitory computer-readable media of clause 11, wherein the context input comprises a first portion of an image.
13. The non-transitory computer-readable media of any of clauses 11-12, wherein the step of generating the additional context comprises causing a generative ML model to generate a description of the first portion of the image.
14. The non-transitory computer-readable media of any of clauses 11-13, wherein the step of generating the additional context comprises determining a first set of annotations corresponding to the first portion of the image.
15. The non-transitory computer-readable media of any of clauses 11-14, wherein the step of generating the additional context comprises identifying a first object within the first portion of the image, and generating a first set of data corresponding to the first object.
16. The non-transitory computer-readable media of any of clauses 11-15, wherein the additional context comprises a first portion of text, the prompt input comprises a second portion of text, and combining the additional context with the prompt input comprises concatenating the first portion of text and the second portion of text.
17. The non-transitory computer-readable media of any of clauses 11-16, further comprising the step of receiving a multimodal prompt that includes the prompt input and the context input, wherein the multimodal prompt includes data from at least two different modalities.
18. The non-transitory computer-readable media of any of clauses 11-17, wherein the context input comprises a portion of domain data corresponding to a first domain of knowledge.
19. The non-transitory computer-readable media of any of clauses 11-18, wherein at least a portion of the additional context comprises a prompt history associated with the first domain of knowledge.
20. In various embodiments, a system comprises one or more memories storing instructions, and one or more processors coupled to the one or more memories that, when executing the instructions, perform the steps of generating additional context for a prompt input based on a context input, combining the additional context with the prompt input to generate a context-enriched prompt, and executing one or more generative machine learning (ML) models on the context-enriched prompt to generate a context-enriched response.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more non-transitory computer readable medium or media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a context-enriched response, the method comprising:
generating additional context for a prompt input based on a context input;
combining the additional context with the prompt input to generate a context-enriched prompt; and
executing one or more generative machine learning (ML) models on the context-enriched prompt to generate the context-enriched response.

2. The computer-implemented method of claim 1, wherein the context input comprises a first portion of an image.

3. The computer-implemented method of claim 2, wherein generating the additional context comprises causing a generative ML model to generate a description of the first portion of the image.

4. The computer-implemented method of claim 2, wherein generating the additional context comprises determining a first set of annotations corresponding to the first portion of the image.

5. The computer-implemented method of claim 2, wherein generating the additional context comprises:
identifying a first object within the first portion of the image; and
generating a first set of data corresponding to the first object.

6. The computer-implemented method of claim 1, wherein the additional context comprises a first portion of text, the prompt input comprises a second portion of text, and combining the additional context with the prompt input comprises concatenating the first portion of text and the second portion of text.

7. The computer-implemented method of claim 1, further comprising receiving a compound prompt that includes the prompt input and the context input.

8. The computer-implemented method of claim 7, wherein the compound prompt comprises a multimodal prompt.

9. The computer-implemented method of claim 1, wherein the context input comprises a portion of domain data derived from a domain catalog, and the domain data corresponds to a first domain of knowledge, and the domain catalog corresponds to a plurality of different domains of knowledge.

10. The computer-implemented method of claim 1, wherein at least a portion of the additional context comprises a prompt history associated with the generative ML model.

11. One or more non-transitory computer-readable media including instructions that, when executed by one or more processors, cause the one or more processors to generate a context-enriched response by performing the steps of:
generating additional context for a prompt input based on a context input;
combining the additional context with the prompt input to generate a context-enriched prompt; and
executing one or more generative machine learning (ML) models on the context-enriched prompt to generate the context-enriched response.

12. The non-transitory computer-readable media of claim 11, wherein the context input comprises a first portion of an image.

13. The non-transitory computer-readable media of claim 12, wherein the step of generating the additional context comprises causing a generative ML model to generate a description of the first portion of the image.

14. The non-transitory computer-readable media of claim 12, wherein the step of generating the additional context comprises determining a first set of annotations corresponding to the first portion of the image.

15. The non-transitory computer-readable media of claim 12, wherein the step of generating the additional context comprises:
identifying a first object within the first portion of the image; and
generating a first set of data corresponding to the first object.

16. The non-transitory computer-readable media of claim 11, wherein the additional context comprises a first portion of text, the prompt input comprises a second portion of text, and combining the additional context with the prompt input comprises concatenating the first portion of text and the second portion of text.

17. The non-transitory computer-readable media of claim 11, further comprising the step of receiving a multimodal prompt that includes the prompt input and the context input, wherein the multimodal prompt includes data from at least two different modalities.

18. The non-transitory computer-readable media of claim 11, wherein the context input comprises a portion of domain data corresponding to a first domain of knowledge.

19. The non-transitory computer-readable media of claim 11, wherein at least a portion of the additional context comprises a prompt history associated with the first domain of knowledge.

20. A system comprising:
one or more memories storing instructions; and
one or more processors coupled to the one or more memories that, when executing the instructions, perform the steps of:
generating additional context for a prompt input based on a context input;
combining the additional context with the prompt input to generate a context-enriched prompt; and
executing one or more generative machine learning (ML) models on the context-enriched prompt to generate a context-enriched response.
